(19) United States
(12) Patent Application Publication
(10) Pub. No.: US 2008/0117977 A1
(43) Pub. Date: May 22, 2008

(54) METHOD AND APPARATUS FOR ENCODING/DECODING IMAGE USING MOTION VECTOR TRACKING

(75) Inventors: Kyo-hyuk LEE, Yongin-si (KR); So-young KIM, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/934,952

(22) Filed: Nov. 5, 2007

Related U.S. Application Data
(60) Provisional application No. 60/856,290, filed on Nov. 3, 2006.

(30) Foreign Application Priority Data
Jan. 3, 2007 (KR) 10-2007-0000706

(51) Int. Cl. H04N 7/26

(52) U.S. Cl. 375/240.16; 375/E07.125

(57) ABSTRACT

A method and apparatus for encoding/decoding an image using motion vector tracking are provided. The image encoding method includes determining corresponding areas of a plurality of reference pictures that are to be used to predict a current block by tracking a motion vector route of a corresponding area of a reference picture referred to by the current block; generating a prediction block of the current block by calculating a weighted sum of the corresponding areas of the plurality of reference pictures; and encoding a difference between the current block and the prediction block.

### CROSS-REFERENCE TO RELATED PATENT APPLICATIONS

This application claims priority from U.S. Provisional Application No. 60/856,290 filed on 3 Nov. 2006 and Korean Patent Application No. 10-2007-0000706, filed on 3 Jan. 2007, in the Korean Intellectual Property Office, the disclosures of which are incorporated herein in their entireties by reference.

### BACKGROUND OF THE INVENTION

1. Field of the Invention

Methods and apparatuses consistent with the present invention relate to prediction-encoding/decoding of an image, and more particularly, to encoding/decoding an image that continuously track routes of motion vectors of a current picture, determine a plurality of reference pictures, and prediction-encode the current picture using the reference pictures.

2. Description of the Related Art

When video is encoded, spatial and temporal redundancies of an image sequence are removed to compress the image sequence. To remove a temporal redundancy, a reference picture located before or after a currently encoded picture is used to search for an area of the reference picture similar to an area of the currently encoded picture, detect a motion between the corresponding areas of the currently encoded picture and the reference picture, and encode a residue between a prediction image obtained by performing motion compensation based on the detected motion and the currently encoded image.

Video pictures are coded in one or more slices. One slice includes at least one macroblock. A video picture may be encoded in a slice. According to the H.264 standard, video pictures are coded in intra (I) slices that are encoded within a picture, predictive (P) slices that are encoded using one reference picture, and bi-predictive (B) slices that are encoded by predicting image samples using two reference pictures.

In the Moving Picture Experts Group 2 (MPEG-2) standard, bi-directional prediction is performed using a picture before a current picture and a picture after the current picture as reference pictures. According to the H.264/Advanced Video Coding (AVC), the bi-directional prediction can use any two pictures without being limited to pictures before and after the current picture, as reference pictures. Pictures that are predicted by using two pictures are defined as bi-predictive pictures (hereinafter referred to as “B pictures”).

FIG. 1 is a diagram illustrating a process of predicting blocks of a current picture that is encoded as a B picture according to the H.264/AVC standard. The H.264/AVC standard predicts the blocks of a B picture by using two reference pictures A and B in a same direction, like a macroblock MB 1, two reference pictures B and C in a different direction, like a macroblock MB2, two areas sampled in two different areas of the same reference picture A, like a macroblock MB3, or an optional reference picture B or D, like a macroblock MB4 or MB5.

Generally, image data coded as a B picture has a higher encoding efficiency than image data coded as an I or P picture. A B picture that uses two reference pictures can generate prediction data which is more similar to current image data than a P picture that uses one reference picture or an I picture that uses prediction within a picture. In addition, since a B picture uses an average value of two reference pictures as prediction data, even if an error occurs between the two reference pictures, less distortion is caused, as if a kind of low frequency filtering is performed.

Since a B picture uses two reference pictures to achieve a higher encoding efficiency than a P picture, if more reference pictures are used in prediction, the encoding efficiency increases. However, if motion prediction and compensation are performed in each reference picture, the amount of operation increases, so the related art image compression standards set a maximum of two reference pictures.

### SUMMARY OF THE INVENTION

The present invention provides a method and apparatus for encoding/decoding an image that track a motion vector route of reference pictures of a current block to predict the current block using more reference pictures in order to improve encoding/decoding efficiencies.

According to an aspect of the present invention, there is provided an image encoding method comprising: determining corresponding areas of a plurality of reference pictures that are to be used to predict a current block by tracking a motion vector route of a corresponding area of a reference picture referred to by the current block; generating a prediction block of the current block by calculating a weighted sum of the corresponding areas of the plurality of reference pictures; and encoding a difference between the current block and the prediction block.

According to another aspect of the present invention, there is provided an image encoding apparatus comprising: a reference picture determination unit determining corresponding areas of a plurality of reference pictures that are to be used to predict a current block by tracking a motion vector route of a corresponding area of a reference picture referred to by the current block; a weight estimation unit generating a prediction block of the current block by calculating a weighted sum of the corresponding areas of the plurality of reference pictures; and an encoding unit encoding a difference between the current block and the prediction block.

According to another aspect of the present invention, there is provided an image decoding method comprising: identifying a prediction mode of a current block by reading prediction mode information included in an input bitstream; if the current block is determined to have been predicted using corresponding areas of a plurality of reference pictures, determining corresponding areas of a plurality of reference pictures that are to be used to predict the current block by tracking a corresponding area of a reference picture referred to by a motion vector route of the current block included in the bitstream and a motion vector route of the corresponding area of the reference picture; generating a prediction block of the current block by calculating a weighted sum of the corresponding areas of the plurality of reference pictures; and decoding the current block by adding a difference between the current block included in the bitstream and the prediction block, and the prediction block.

According to another aspect of the present invention, there is provided an image decoding apparatus comprising: a prediction mode identification unit which identifies a prediction mode of a current block by reading prediction mode information included in an input bitstream; a reference picture determination unit which, if the current block is determined to have been predicted using corresponding areas of a plurality of reference pictures, determines corresponding areas of a plurality of reference pictures that are to be used to predict the current block by tracking a corresponding area of a reference picture referred to by a motion vector route of the current block included in the bitstream and a motion vector route of the corresponding area of the reference picture; a weight prediction unit which generates a prediction block of the current block by calculating a weighted sum of the corresponding areas of the plurality of reference pictures; and a decoding unit which decodes the current block by adding a difference between the current block included in the bitstream and the prediction block, and the prediction block.

### BRIEF DESCRIPTION OF THE DRAWINGS

The above and other aspects of the present invention will become more apparent by describing in detail exemplary embodiments thereof with reference to the attached drawings in which:

FIG. 1 is a diagram illustrating a process of predicting blocks of a current picture that is encoded as a bi-predictive (B) picture according to the H.264/AVC standard;

FIG. 2 is a diagram illustrating a process of determining a plurality of reference pictures used to predict a current picture according to an image encoding method of an exemplary embodiment of the present invention;

FIG. 3 is a diagram illustrating a process of determining a plurality of reference pictures used to predict a current picture according to an image encoding method of another exemplary embodiment of the present invention;

FIG. 4 is a diagram illustrating a process of determining a plurality of reference pictures used to predict a current picture according to an image encoding method of another exemplary embodiment of the present invention;

FIG. 5 is a block diagram of an image encoding apparatus according to an exemplary embodiment of the present invention;

FIG. 6 is a block diagram of a motion compensation unit illustrated in FIG. 5 according to an exemplary embodiment of the present invention;

FIG. 7 is a diagram illustrating blocks of various sizes used to predict motion of a variable block in the H.264/MPEG-4 AVC standard according to an exemplary embodiment of the present invention;

FIG. 8 is an image generated by predicting motion of the variable block according to an exemplary embodiment of the present invention;

FIG. 9 is a diagram for explaining a process of determining corresponding areas of other reference pictures referred to by sub-corresponding areas of a reference picture that are divided along motion block boundaries according to an image encoding method of an exemplary embodiment of the present invention;

FIG. 10 is a diagram for explaining a process of determining corresponding areas of other reference pictures referred to by sub-corresponding areas of a reference picture that are divided along motion block boundaries according to an image encoding method of another exemplary embodiment of the present invention;

FIG. 11 is a diagram illustrating a process of calculating weights allocated to corresponding areas of reference pictures according to an image encoding method of an exemplary embodiment of the present invention;

FIG. 12 is a flowchart illustrating an image encoding method according to an exemplary embodiment of the present invention;

FIG. 13 is a block diagram of an image decoding apparatus according to an exemplary embodiment of the present invention; and

FIG. 14 is a flowchart illustrating an image decoding method according to an exemplary embodiment of the present invention.

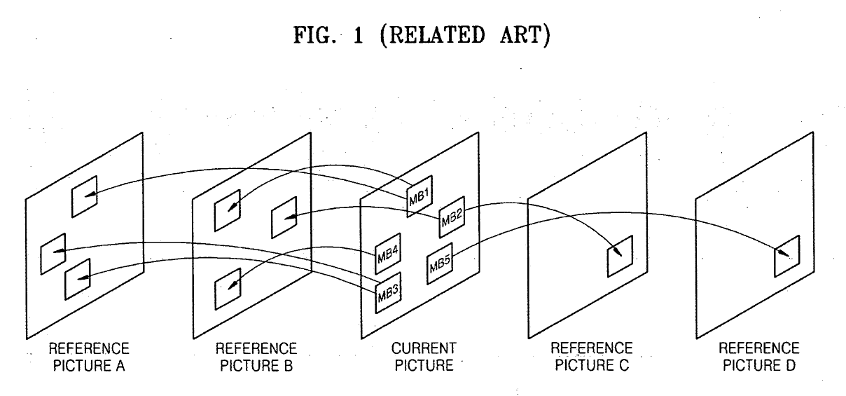

### DETAILED DESCRIPTION OF EXEMPLARY EMBODIMENTS

Exemplary embodiments of the present invention will now be described in detail with reference to the accompanying drawings.

An image encoding method according to an exemplary embodiment of the present invention uses a motion vector of a reference picture indicated by a motion vector of a current picture to continuously track corresponding areas of other reference pictures, thereby determining a plurality of reference pictures that are to be used for prediction of the current picture, calculating a weighted sum of the plurality of reference pictures, and generating a prediction value of the current picture.

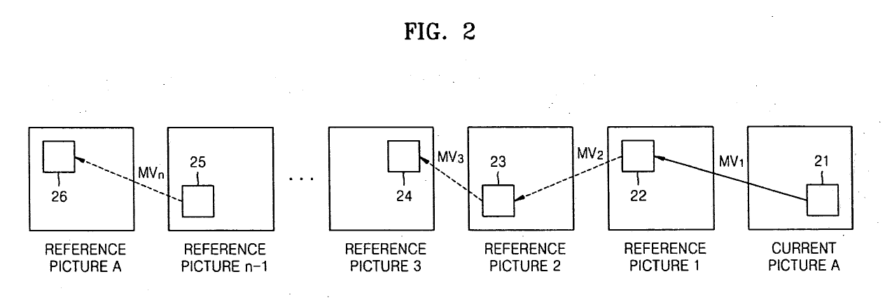

A process of determining the plurality of reference pictures used by the image encoding method and apparatus according to exemplary embodiments of the present invention will now be described with reference to FIGS. 2 through 4.

FIG. 2 is a diagram illustrating a process of determining a plurality of reference pictures used to predict a current picture according to an image encoding method of an exemplary embodiment of the present invention.

Referring to FIG. 2, it is assumed that a general motion prediction of a block 21 (hereinafter referred to as “a current block”) that is to be encoded in a current picture A is performed, and thus a motion vector MV1 indicating a corresponding area 22 of a reference picture 1 that is most similar to the current block 21 is determined. It is also assumed that the current picture A is a predictive(P) picture, and the current block 21 is a motion block referring to only one reference picture. However, the present invention can be applied to track each motion vector of a motion block having two motion vectors in a bi-predictive (B) picture as well as the motion block having one motion vector shown in a P picture of FIG. 2.

Referring to FIG. 2, the motion vector MV1 generated by motion prediction of the current block 21 indicates an area having the least error with the current block 21 in the reference picture 1. In a related art, the value of the corresponding area 22 of the reference picture 1 is determined as a prediction value of the current block 21, and a residue, that is a difference between the prediction value and an original pixel value of the current block 21, is encoded.

The image encoding method of the present exemplary embodiment predicts a current block by using a corresponding area of a first reference picture indicated by a motion vector of the current block, as in the related art, and by using a corresponding area of a second reference picture used to predict the corresponding area of the first reference picture using motion information of the corresponding area of the reference picture as well. For example, a motion vector MV2 of the corresponding area 22 of the reference picture 1 corresponding to the current block 21 is used to determine a corresponding area 23 of a reference picture 2 used to predict the corresponding area 22 of the reference picture 1. A motion vector MV3 of the corresponding area 23 of the reference picture 2 is used to determine a corresponding area 24 of a reference picture 3 used to predict the corresponding area 23 of the reference picture 2. A motion vector MVn of the corresponding area 25 of the reference picture n−1 is used to determine a corresponding area 26 of a reference picture A used to predict the corresponding area 25 of the reference picture n−1. As will be described later, the process of tracking the corresponding area of the first reference picture indicated by the motion vector of the current block, or the corresponding area of the second reference picture indicated by the motion vector of the corresponding area of the first reference picture, is continuously performed up to a reference picture including only an intra-predicted block or a reference picture including an intra-predicted block having a corresponding area greater than a threshold value.

In the present exemplary embodiment, a prediction block of the current block 21 is generated by tracking motion vector routes such as a motion vector route of the corresponding area 22 of the reference picture 1 indicated by the motion vector MV1 of the current block 21, a motion vector route of the corresponding area 23 of the reference picture 2 indicated by the motion vector MV2 of the corresponding area 22 of the reference picture 1, and a motion vector route of the corresponding area 24 of the reference picture 3 indicated by the motion vector MV3 of the corresponding area 23 of the reference picture 2, multiplying a predetermined weight by each corresponding area of the plurality of reference pictures, and adding the results.

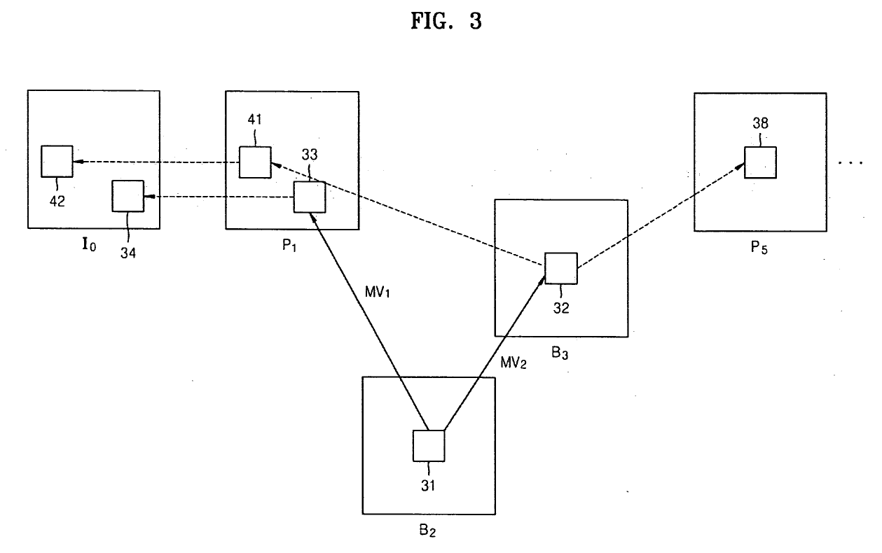

FIG. 3 is a diagram illustrating a process of determining a plurality of reference pictures used to predict a current picture according to an image encoding method of another exemplary embodiment of the present invention. Referring to FIG. 3, it is assumed that I₀ is an intra (I) picture, P₁ and P₅ are P pictures, and B₂ and B₃ are B pictures. The process of determining corresponding areas of a plurality of reference pictures used to predict a current block 31 of the B₂ picture will now be described.

It is assumed that the current block 31 of the B₂ picture has two motion vectors MV1 and MV2 as a result of general motion prediction. If the current block that is to be encoded has two motion vectors, like the current block 31 of the B₂ picture, each motion vector route of corresponding areas of reference pictures is tracked to determine the corresponding areas of the reference pictures. Motion information of a corresponding area 33 of the reference picture P₁ indicated by the first motion vector MV1 of the current block 31 is used to determine a corresponding area 34 of the reference picture I₀ used to predict the corresponding area 33 of the reference picture P₁. Since the reference picture I₀ is an I picture including intra-predicted blocks, the corresponding area 34 of the reference picture I₀ has no motion information and thus tracking is stopped.

In a similar way, a corresponding area 32 of the reference picture B₃ indicated by the second motion vector MV2 of the current block 31 has two motion vectors, since the reference picture B₃ is a B picture. Of two motion vectors of the corresponding area 32 of the reference picture B₃, the motion vector on the left is tracked to determine a corresponding area 41 of the reference picture P₁ used to predict the corresponding area 32 of the reference picture B₃ and a corresponding area 42 of the reference picture I₀ used to predict the corresponding area 41 of the reference picture P₁. The motion vector on the right is tracked to determine a corresponding area 38 of the reference picture P₅ used to predict the corresponding area 32 of the reference picture B₃. As described above, the process of tracking the right motion vector of the corresponding area 32 of the reference picture B₃ is continuously performed up to an intra-predicted block having no motion information or a reference picture including an intra-predicted block having a corresponding area greater than a threshold value.

In the present exemplary embodiment, a prediction block of the current block 31 is generated by tracking the two motion vectors MV1 and MV2 of the current block 31, multiplying a predetermined weight by each of the corresponding areas 32, 33, 34, and 38 of the plurality of reference pictures, and adding the results.

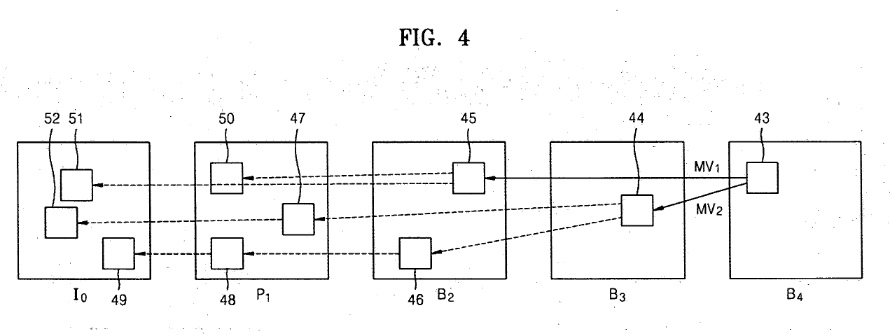

FIG. 4 is a diagram illustrating a process of determining a plurality of reference pictures used to predict a current picture according to an image encoding method of another exemplary embodiment of the present invention. A motion vector tracking process of the present exemplary embodiment is similar to that of a previous exemplary embodiment described with reference to FIG. 3, except that an encoded picture before a current picture is only used. According to the H.264/AVC standard, reference pictures are not limited to two pictures before and after the current picture, but can be two pictures in an optional direction. Thus, referring to FIG. 4, pictures only before a current picture can be used to perform prediction encoding.

Two motion vectors MV1 and MV2 of a current block 43 are tracked to determine corresponding areas 44 through 52 of a plurality of reference pictures used to predict the current block 43.

As described above, the image encoding method and apparatus of the exemplary embodiment of the present invention use a corresponding area of a reference picture indicated by a motion vector of a current block and corresponding areas of other reference pictures used to predict the corresponding area of the reference picture by using motion information of the corresponding area of the reference picture to predict the current block. If the current block or the corresponding area of the reference picture has two motion vectors, each motion vector is tracked to determine corresponding areas of other reference pictures.

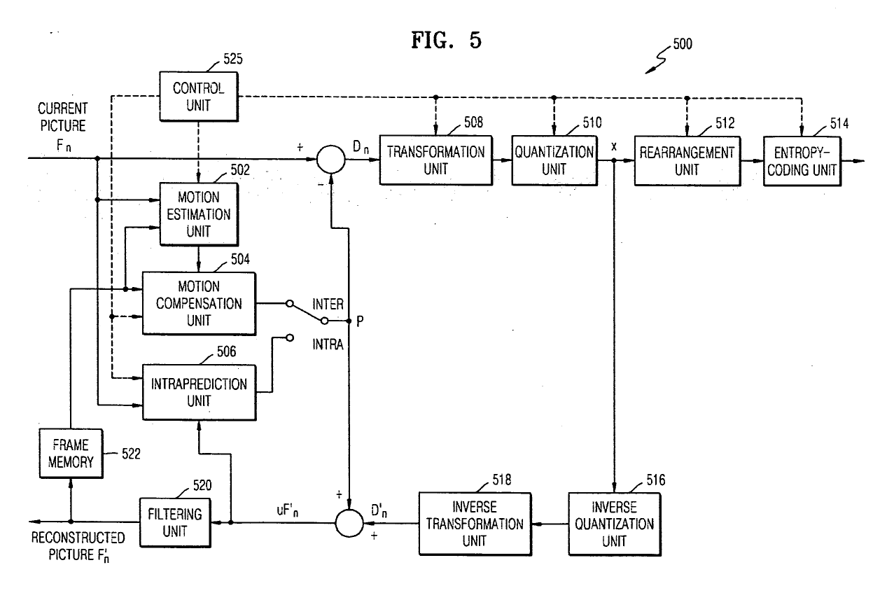

FIG. 5 is a block diagram of an image encoding apparatus 500 according to an exemplary embodiment of the present invention. For the convenience of description, it is assumed that the image encoding apparatus follows the H.264/AVC standard. However, the image encoding apparatus of the exemplary embodiment of the present invention can be applied to a different image coding method using motion prediction and compensation.

Referring to FIG. 5, the image encoding apparatus 500 includes a motion estimation unit 502, a motion compensation unit 504, an intra-prediction unit 506, a transformation unit 508, a quantization unit 510, a rearrangement unit 512, an entropy-coding unit 514, an inverse quantization unit 516, an inverse transformation unit 518, a filtering unit 520, a frame memory 522, and a control unit 525.

The motion estimation unit 502 divides a current picture into blocks of a predetermined size, performs motion estimation by searching for an area that is most similar to a current block within a predetermined search area range of a reference picture that has been previously encoded and then reconstructed and then stored in the picture memory 522, and outputs a motion vector indicating the difference in location between the current block and a corresponding area of the reference picture.

The motion compensation unit 504 uses information on the corresponding area of the reference picture indicated by the motion vector to generate a prediction value of the current block. In particular, as described above, the motion compensation unit 504 of the present exemplary embodiment continuously tracks the motion vector of the current block to determine corresponding areas of a plurality of reference pictures, calculates a weighted sum of the corresponding areas of the plurality of reference pictures, and generates the prediction value of the current block. The detailed constitution and operation of the motion compensation unit 504 of the present exemplary embodiment will be described later.

The intra-prediction unit 506 performs intra-prediction for the prediction value of the current block.

Once a prediction block of the current block is generated by inter-prediction, intra-prediction or a prediction method using the corresponding areas of the plurality of reference pictures of the present exemplary embodiment, a residue corresponding to an error value between the current block and the prediction block is generated, transformed into the frequency domain by the transformation unit 508, and then quantized by the quantization unit 510. The entropy-coding unit 514 encodes the quantized residue, thereby outputting a bitstream.

The quantized picture is reconstructed by the inverse quantization unit 516 and the inverse transformation unit 518 in order to obtain the reference picture. The reconstructed current picture passes through the filtering unit 520 that performs deblocking filtering and is then stored in the frame memory 522 in order to be used to predict a next picture.

The control unit 525 controls components of the image encoding apparatus 500 and determines a prediction mode for the current block. More specifically, the control unit 525 compares the costs of the prediction block generated by general inter-prediction, intra-prediction and the prediction using the corresponding areas of the plurality of reference pictures according to an exemplary embodiment of the present invention and the current block, and selects a prediction mode having the minimum cost for the current block. Such costs can be calculated in various manners using different cost functions, such as a sum of absolute difference (SAD) cost function, a sum of absolute transformed difference (SATD) cost function, a sum of squared difference (SSD) cost function, a mean of absolute difference (MAD) cost function, and a Lagrange cost function. The SAD is the sum of the absolute values of prediction errors (i.e. residues) of 4×4 blocks. The SATD is the sum of the absolute values of coefficients obtained by applying a Hadamard transformation to the prediction errors of the 4×4 blocks. The SSD is the sum of the squares of the prediction errors of the 4×4 blocks. The MAD is the average of the absolute values of the prediction errors of the 4×4 blocks. The Lagrange function is a new cost function including length information of a bitstream.

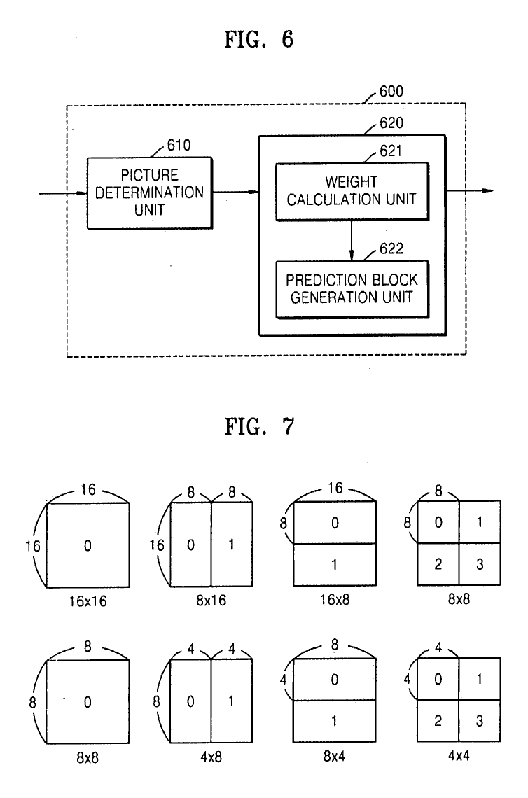

FIG. 6 is a block diagram of the motion compensation unit 504 illustrated in FIG. 5 according to an exemplary embodiment of the present invention. Referring to FIG. 6, the motion compensation unit 600 of the exemplary embodiment of the present invention includes a reference picture determination unit 610 and a weight estimation unit 620.

The reference picture determination unit 610 uses the motion vector of the current block generated by the motion estimation unit 502 to determine the corresponding areas of the reference picture and track a route of a motion vector of the corresponding area of the reference picture, thereby determining the corresponding areas of the plurality of reference pictures that are to be used to predict the current block.

The weight estimation unit 620 calculates the weighted sum of the corresponding areas of the plurality of reference pictures to generate the prediction block of the current block. The weight estimation unit 620 includes a weight calculation unit 621 that determines weights of the corresponding areas of the plurality of reference pictures, and a prediction block generation unit 622 that multiplies the weights by the corresponding areas of the plurality of reference pictures and adds the results to generate the prediction block of the current block.

The operation of the reference picture determination unit 610 determining the corresponding areas of the plurality of reference pictures that are to be used to predict the current block will now be described in detail.

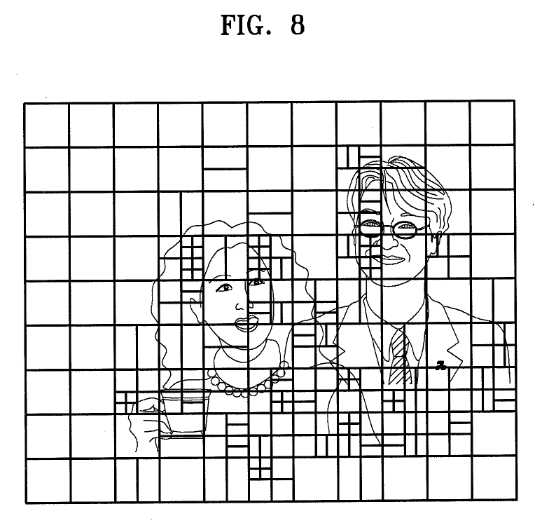

FIG. 7 is a diagram illustrating blocks of various sizes used to predict motion of a variable block in the H.264/MPEG-4 AVC standard. FIG. 8 is an image generated by predicting a motion of a variable block.

Referring to FIG. 7, four methods can be used to divide a macroblock: the macroblock can be divided into one 16×16 macroblock partition, two 16×8 partitions, two 8×16 partitions, or four 8×8 partitions, to predict a motion of the macroblock. In an 8×8 mode, four methods can be used to divide each of the four 8×8 sub-macroblocks: each 8×8 sub-macroblock can be divided into one 8×8 sub-macroblock partition, two 8×4 sub-macroblock partitions, two 4×8 sub-macroblock partitions, or four 4×4 sub-macroblock partitions. A variety of combinations of these partitions and sub-macroblocks can be made in each macroblock. Such a division of the macroblock into sub-blocks of various sizes is called tree structured motion compensation.

Referring to FIG. 8, motion of blocks having low energy in the image are predicted in large partitions, and motion of blocks having high energy in the image are predicted in small partitions. A boundary between motion blocks for dividing a current picture using the tree structured motion compensation is defined as a motion block boundary.

As described above, the image encoding method according to the exemplary embodiment of the present invention tracks a motion vector of a corresponding area of a reference picture in order to determine corresponding areas of a plurality of reference pictures that are to be used to predict a current block. However, as shown in FIG. 8, since the reference picture is divided into motion blocks of various sizes, the corresponding area of the reference picture corresponding to the current block does not exactly match a motion block but is included in a plurality of motion blocks. In this case, the corresponding area of the reference picture includes a plurality of motion vectors. A process of tracking the plurality of motion vectors included in the corresponding area of the reference picture will now be described.

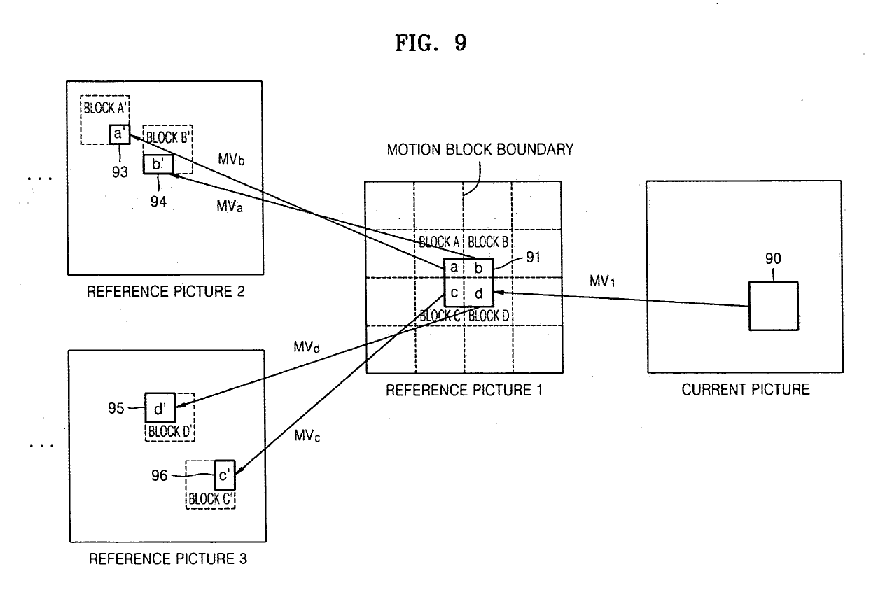

FIG. 9 is a diagram for explaining a process of determining corresponding areas of other reference pictures referred to by sub-corresponding areas of a reference picture that are divided along motion block boundaries according to an image encoding method of an exemplary embodiment of the present invention. Referring to FIG. 9, a corresponding area 91 of a reference picture 1 indicated by a motion vector MV1 of a current block 90 is included in a plurality of motion blocks. In more detail, the corresponding area 91 of the reference picture 1 corresponding to the current block 90 does not match one of the plurality of motion blocks but is included in the motion blocks A, B, C, and D. In this case, the reference picture determination unit 610 divides the corresponding area 91 of the reference picture 1 along the motion block boundaries of the reference picture 1 and determines corresponding areas of reference pictures 2 and 3 indicated by a motion vector of each motion block of the reference picture 1 including sub-corresponding areas a, b, c, and d. In more detail, the reference picture determination unit 610 determines a corresponding area a′ 93 of the reference picture 2 by using a motion vector MVa of the motion block A to which the sub-corresponding area a belongs, a corresponding area b′ 94 of the reference picture 2 by using a motion vector MVb of the motion block B to which the sub-corresponding area b belongs, a corresponding area c′ 96 of the reference picture 3 by using a motion vector MVc of the motion block C to which the sub-corresponding area c belongs, and a corresponding area d′ 95 of the reference picture 3 by using a motion vector MVd of the motion block D to which the sub-corresponding area d belongs.

In the present exemplary embodiment, the motion blocks A, B, C, and D that partially include the corresponding area 91 of the reference picture 1 corresponding to the current block 90 refer to the reference pictures 2 and 3. However, even when the motion blocks A, B, C, and D change their reference pictures, motion field information of the motion blocks A, B, C, and D, i.e. motion vectors and reference picture information of the motion blocks A, B, C, and D, can be used to determine corresponding areas of other reference pictures that correspond to the sub-corresponding areas of the reference picture 1.

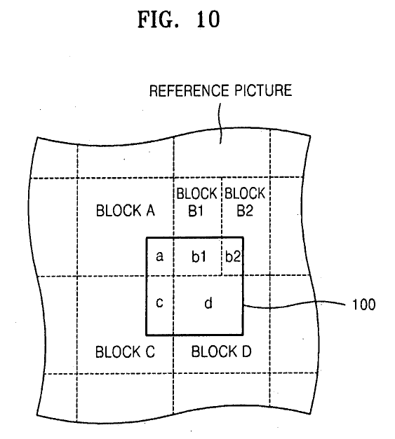

FIG. 10 is a diagram for explaining a process of determining corresponding areas of other reference pictures referred to by sub-corresponding areas of a reference picture that are divided along motion block boundaries according to an image encoding method of another exemplary embodiment of the present invention. Referring to FIG. 10, when a corresponding area 100 of a reference picture with regard to a current block is partially included in motion blocks A, B1, B2, C, and D, as described above, the corresponding area 100 of the reference picture is divided along the motion block boundaries of the reference block, and motion field information of the motion blocks to which sub-corresponding areas a, b1, b2, c, and d belong is used to determine corresponding areas of other reference pictures. In more detail, the reference picture determination unit 610 determines a corresponding area of other reference picture corresponding to the sub-corresponding area a by using motion field information of the motion block A to which the sub-corresponding area a belongs, a corresponding area of other reference picture corresponding to the sub-corresponding area b1 by using motion field information of the motion block B1 to which the sub-corresponding area b1 belongs, a corresponding area of other reference picture corresponding to the sub-corresponding area b2 by using motion field information of the motion block B2 to which the sub-corresponding area b2 belongs, a corresponding area of other reference picture corresponding to the sub-corresponding area c by using motion field information of the motion block C to which the sub-corresponding area c belongs, and a corresponding area of other reference picture corresponding to the sub-corresponding area d by using motion field information of the motion block D to which the sub-corresponding area d belongs.

The process of determining a reference picture is used to determine a corresponding area of a second reference picture according to a corresponding area of a first reference picture indicated by a motion vector of a current block, and also to determine a third reference picture according to the corresponding area of the second reference picture. Motion vector based tracking can be continuously performed only when a corresponding area is included in a motion block having motion vector information. However, when a corresponding area is included in an intra-prediction block or the corresponding area included in the intra-prediction block is greater than a threshold value, the tracking is performed with reference to a corresponding reference picture. For example, referring back to FIG. 9, if the blocks A, B, C, and D to which the corresponding area 91 of the reference picture 1 corresponding to the current block 90 belongs are all intra-prediction blocks, tracking is no longer performed and the corresponding area 91 of the reference picture 1 only is used to predict the current block 90. Also, if the blocks A, B, and C are motion blocks having motion vectors, and the block D is an intra-prediction block, when the sub-corresponding area d belonging to the block D is greater than the threshold value, a value obtained by multiplying a weight by the corresponding area 91 of the reference picture 1 is used to predict the current bock 90. The process of determining whether to continuously perform tracking is correspondingly applied to corresponding areas of other reference pictures determined according to a reference picture.

If one of the corresponding areas is included in an intra-prediction block but the corresponding area included in the intra-prediction block is smaller than the threshold value, the tracking process of determining the corresponding areas of other reference pictures is continuously performed. In this regard, motion vectors of neighboring motion blocks of the intra-prediction block are used to allocate a virtual motion vector to the intra-prediction block, and determine the corresponding areas of other reference pictures indicated by the virtual motion vector. In the example mentioned above, supposing that the blocks A, B, and C include the motion vectors MVa, MVb, and MVc, respectively, the block D is an intra-prediction block, and the sub-corresponding area d of the block D is smaller than the threshold value, the tracking process is continuously performed. In this case, as described above, with regard to the sub-corresponding areas a, b, and c belonging to the blocks A, B, and C, a median value or mean value of the motion vectors MVa, MVb, and MVc of the blocks A, B, and C is allocated to a virtual motion vector of the block D, and the corresponding areas of other reference pictures indicated by the virtual motion vector are determined.

Referring back to FIG. 6, if the reference picture determination unit 610 tracks the route of the motion vector of the current block and determines the corresponding areas of the plurality of reference pictures, the weight calculation unit 621 calculates the weights allocated to all the corresponding areas.

The weight calculation unit 621 uses previously processed pixels of neighboring blocks of the current block and neighboring pixels of the corresponding areas of the reference pictures corresponding to the previously processed pixels of neighboring blocks of the current block to determine, as weights, values of the minimum difference between prediction values of the pixels of neighboring blocks of the current block obtained by calculating the weighted sum of neighboring pixels of the corresponding areas of the reference pictures and values of the pixels of neighboring blocks of the current block.

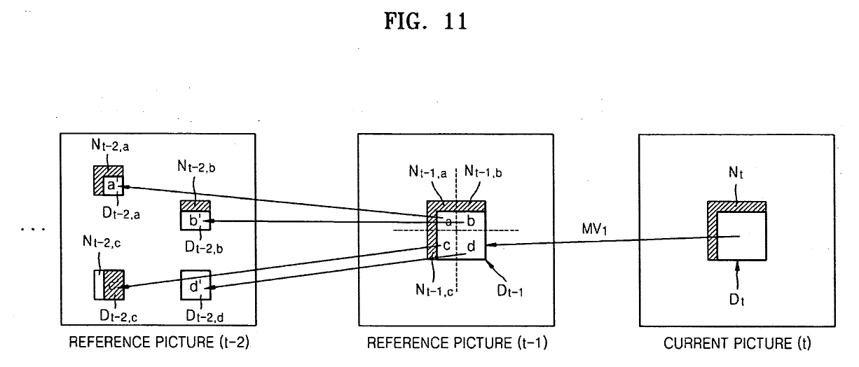

FIG. 11 is a diagram illustrating a process of calculating weights allocated to corresponding areas of reference pictures according to an image encoding method of an exemplary embodiment of the present invention. Referring to FIG. 11, it is assumed that Dₜ denotes a current block, Dₜ₋₁ denotes a corresponding area of a reference picture t−1 corresponding to the current block Dₜ, Dₜ₋₂,a, Dₜ₋₂,b, Dₜ₋₂,c, and Dₜ₋₂,d (comprehensively referred to as “Dₜ₋₂”) denote corresponding areas of a reference picture t−2 corresponding respectively to sub-divided areas a, b, c, and d of the corresponding area Dₜ₋₁, and Pₜ denotes a prediction block of the current block Dₜ.

The weight calculation unit 621 allocates weights for each reference picture. In more detail, the weight calculation unit 621 allocates equal weights to corresponding areas belonging to a same reference picture. If a weight α is allocated to the corresponding area Dₜ₋₁ of the reference picture t−1, and a weight β is allocated to the corresponding areas Dₜ₋₂ of the reference picture t−2, the prediction block Pₜ of the current block Dₜ is obtained by calculating a weighted sum of the corresponding area Dₜ₋₁ of the reference picture t−1 and the corresponding areas Dₜ₋₂ of the reference picture t−2 according to equation 1.

Pₜ=α·Dₜ₋₁+β·Dₜ₋₂ (1)

The weights α and β allocated to the corresponding areas of the reference pictures can be determined using various algorithms. An exemplary embodiment of the present invention uses the weights which result in a minimum error between the prediction block Pₜ and the current block Dₜ. A sum of squared error (SSE) between the prediction block Pₜ and the current block Dₜ is calculated according to equation 2.

SSE=Σ(Dₜ−Pₜ)²=Σ[Dₜ−(α·Dₜ₋₁+β·Dₜ₋₂)]² (2)

The weights α and β can be determined by calculating a partial differential equation (PDE) according to equation 3 and obtaining a result of 0.

$$\frac{\partial SSE}{\partial α} = 0 , \frac{\partial SSE}{\partial β} = 0 \qquad ( 3 )$$

The PDE of equation 3 is calculated using pixels of neighboring blocks of a current block and neighboring pixels of corresponding areas of reference pictures corresponding to the pixels of neighboring blocks of the current block. This is because weights can be determined using previously decoded information on the pixels of neighboring blocks of the current block without needing to transmit weights used to predict the current block. Therefore, the exemplary embodiment of the present invention uses the pixels of neighboring blocks of the current block and the neighboring pixels of corresponding areas of reference pictures corresponding to the pixels of neighboring blocks of the current block in order to determine weights using data previously processed by an encoder and a decoder, avoiding the need to transmit weights allocated to corresponding areas of reference pictures.

Similarly to the calculation of the prediction block Pₜ of the current block Dₜ using the corresponding area Dₜ₋₁ of the reference picture t−1 and the corresponding areas Dₜ₋₂ of the reference picture t−2, pixels Nₜ of neighboring blocks of the current block can be calculated by using neighboring pixels Nₜ₋₁,a, Nₜ₋₁,b, and Nₜ₋₁,c of the corresponding area Dₜ₋₁ of the reference picture t−1 and neighboring pixels Nₜ₋₂,a, Nₜ₋₂,b, and Nₜ₋₂,c of the corresponding areas Dₜ₋₂ of the reference picture t−2, considering spatial locations of the current block Dₜ. In this case, an SSE between prediction values Nₜ′ of the pixels of the neighboring blocks of the current block Dₜ obtained by using the neighboring pixels Nₜ₋₁ of the corresponding area Dₜ₋₁ of the reference picture t−1 and the neighboring pixels Nₜ₋₂ of the corresponding areas Dₜ₋₂ of the reference picture t−2, and the pixels Nₜ of neighboring blocks of the current block is calculated according to equation 4.

SSE of neighbor pixels=Σ(Nₜ−Nₜ′)²=Σ[Nₜ−(α·Nₜ₋₁+β·Nₜ₋₂)]² (4)

The weight calculation unit 621 determines the weights α and β by calculating the PDE of the SSE, and obtaining a result of 0.

In Equation 1, if values of weights α and β are normalized so that α+β=1, β=1−α. β=1−α is substituted into equation 1 to give equations 5 and 6 below.

Pₜ=α·Dₜ₋₁+(1−α)·Dₜ₋₂ (5)

SSE=Σ(Dₜ−Pₜ)²=Σ[Dₜ−(α·Dₜ₋₁+(1−α)·Dₜ₋₂)]² (6)

The weight α satisfying

$$\frac{\partial SSE}{\partial α} = 0$$

by calculating the PDE of the SSE according to equation 6 is obtained according to equation 7.

$$α = \frac{Σ [ ( {D}_{t} - {D}_{t - 2} ) \cdot ( {D}_{t - 2} - {D}_{t - 1} ) ]}{{Σ ( {D}_{t - 2} - {D}_{t - 1} )}^{2}} \qquad ( 7 )$$

As described above, the pixels Nₜ of the previously processed neighboring blocks, the neighboring pixels Nₜ₋₂, and the neighboring pixels Nₜ₋₁ are used, respectively, instead of the current block Dₜ, the corresponding areas Dₜ₋₂, and the corresponding areas Dₜ₋₁, in order to determine the weights without transmitting each weight allocated to the corresponding areas.

The weights are determined by allocating a weight to each reference picture when corresponding areas of a larger number of reference pictures are used, and determining the weights resulting in the minimum error between a current block and a prediction block.

In more detail, if D1, D2, D3, . . . Dn denote corresponding areas of n (n is an integer) reference pictures used to predict the current block Dₜ, and W1, W2, W3, . . . Wn denote weights allocated to each corresponding area, the prediction block Pₜ of the current block Dₜ is calculated using Pₜ=W1*D1+W2*D2+W3*D3+ . . . +Wn*Dn. The weights W1, W2, W3, . . . Wn are determined by calculating the PDE of the SSE, that is the square of an error value between the prediction block Pₜ and the current block Dₜ, using the weights as parameters and obtaining a result of 0. As described above, pixels of neighboring blocks of a current block and corresponding neighboring pixels of corresponding areas of reference pictures are used to calculate the PDE.

Referring back to FIG. 6, the prediction block generation unit 622 multiplies the weights by the corresponding areas of the plurality of reference pictures, adds the results, and generates the prediction block of the current block.

The motion compensation unit 504 according to an exemplary embodiment of the present invention transforms a residue, that is a difference between the prediction block obtained by using the corresponding areas of the plurality of reference pictures and the current block, quantizes the residue, and entropy-encodes the residue, thereby outputting a bitstream.

A one-bit flag indicating whether each block has been motion-predicted using corresponding areas of a plurality of reference pictures may be inserted into a header of a bitstream to be encoded according to an image encoding method according to an exemplary embodiment of the present invention. For example, “0” indicates a bitstream encoded according to the conventional art, and “1” indicates a bitstream encoded according to the exemplary embodiment of the present invention.

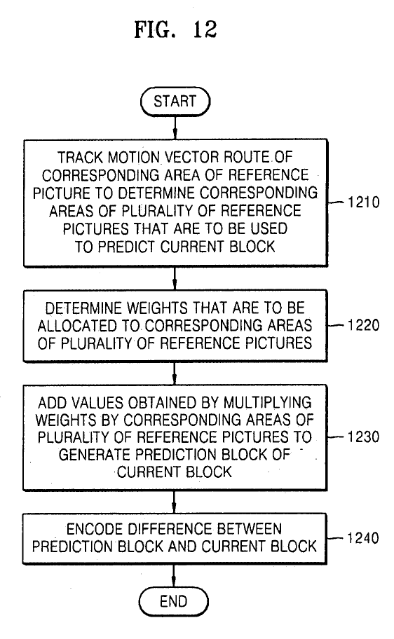

FIG. 12 is a flowchart illustrating an image encoding method according to an exemplary embodiment of the present invention. Referring to FIG. 12, a motion vector route of a corresponding area of a reference picture referred to by a current block is tracked to determine corresponding areas of a plurality of reference pictures that are to be used to predict the current block (Operation 1210). As described above, when the corresponding area of the reference picture is divided by motion block boundaries, a motion vector of a motion block to which each corresponding area belongs is used to determine the corresponding areas of the plurality of reference pictures.

Weights that are to be allocated to the corresponding areas of the plurality of reference pictures are determined (Operation 1220). As described above, the weights of the corresponding areas are determined as values minimizing the differences between original neighboring pixels and neighboring pixels of the current block that are predicted from neighboring pixels of corresponding areas by using the neighboring pixels of the current block and neighboring pixels of the corresponding areas of the plurality of reference pictures corresponding to the neighboring pixels of the current block.

Values obtained by multiplying the weights by the corresponding areas of the plurality of reference pictures are added to generate a prediction block of the current block (Operation 1230).

A residue, that is the difference between the prediction block and the current block, is transformed, quantized, and entropy-encoded, thereby outputting a bitstream (Operation 1240).

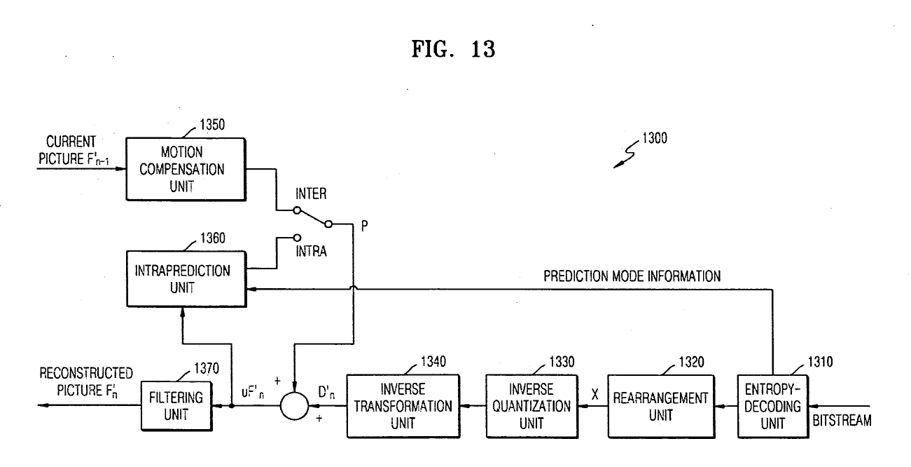

FIG. 13 is a block diagram of an image decoding apparatus 1300 according to an exemplary embodiment of the present invention. Referring to FIG. 13, the image decoding apparatus 1300 of the present exemplary embodiment includes an entropy-decoding unit 1310, a rearrangement unit 1320, an inverse quantization unit 1330, an inverse transformation unit 1340, a motion compensation unit 1350, an intraprediction unit 1360, and a filtering unit 1370.

The entropy-decoding unit 1310 and the rearrangement unit 1320 receive a compressed bitstream and perform entropy-decoding on the received bitstream, thereby generating quantized coefficients. The inverse quantization unit 1330 and the inverse transformation unit 1340 perform inverse quantization and inverse transformation of the quantized coefficients, thereby extracting transformation coding coefficients, motion vector information, and prediction mode information. The prediction mode information may include a flag indicating whether the current block to be decoded has been encoded by adding the weights using corresponding areas of a plurality of reference pictures according to the image encoding method of an exemplary embodiment of the present invention. As mentioned above, corresponding areas of the plurality of reference pictures that are to be used to decode the current block can be determined using motion vector information of the current block that is to be decoded in the same manner as the image encoding method, it is not necessary to transmit information on the corresponding areas of the plurality of reference pictures that are to be used to decode the current block.

The intraprediction unit 1360 generates the prediction block of the current block using a neighboring block of the current block, which has been decoded prior to the intraprediction-encoded current block.

The motion compensation unit 1350 operates in the same manner as the motion compensation unit 504 illustrated in FIG. 5. In other words, when the current block to be decoded is prediction-encoded by calculating the weighted sum of the corresponding areas of the plurality of reference pictures, the motion compensation unit 1350 uses a motion vector of the current block included in the bitstream to track corresponding areas of previously encoded reference pictures, thereby determining corresponding areas of a plurality of reference pictures, determining weights to be allocated to the corresponding areas of each reference picture, multiplying the weights by the corresponding areas of the plurality of reference pictures, adding the results, and generating the prediction value of the current block. As described above, the weights to the corresponding areas of the plurality of reference pictures are determined using neighboring pixels of a previously decoded current block and neighboring pixels of the corresponding areas of the plurality of reference pictures corresponding to the neighboring pixels of the current block.

An error value D′n between the current block and the prediction block is extracted from the bitstream and then added to the prediction block generated by the motion compensation unit 1350 and the intraprediction unit 1360, thereby generating reconstructed video data uF′n. uF′n passes through the filtering unit 1370, thereby completing decoding on the current block.

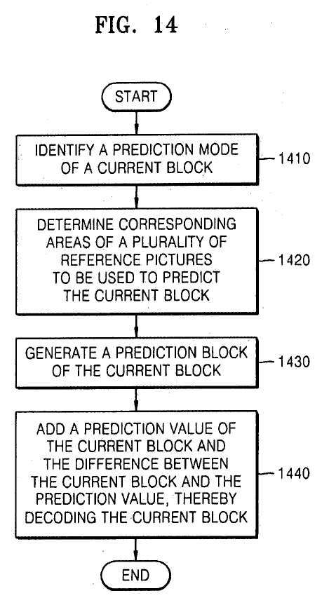

FIG. 14 is a flowchart illustrating an image decoding method according to an exemplary embodiment of the present invention. Referring to FIG. 14, prediction mode information included in an input bitstream is read in order to identify a prediction mode of a current block (Operation 1410).

If the current block to be decoded is determined to have been predicted using corresponding areas of a plurality of reference pictures, a corresponding area of a reference picture referred to by a motion vector route of the current block included in the bitstream and a motion vector route of the corresponding area of the reference picture are tracked to determine corresponding areas of a plurality of reference pictures to be used to predict the current block (Operation 1420).

Neighboring pixels of a previously decoded current block and neighboring pixels of the corresponding areas of the plurality of reference pictures corresponding to the neighboring pixels of the current block are used to determine weights allocated to the corresponding areas of the plurality of reference pictures and generate the prediction block of the current block by calculating a weighted sum of the corresponding areas of the plurality of reference pictures (Operation 1430).

The prediction value of the current block and the difference between the current block and the prediction value, which are included in the bitstream, are added, thereby decoding the current block (Operation 1440).

The exemplary embodiments of the present invention can also be embodied as computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion.

According to the exemplary embodiments of the present invention, a greater number of reference pictures are used to prediction-encode a current block, thereby improving prediction and encoding efficiency.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. An image encoding method comprising:
determining corresponding areas of a plurality of reference pictures that are to be used to predict a current block of a current picture by tracking a motion vector route of a corresponding area of a reference picture referred to by the current block;
generating a prediction block of the current block by calculating a weighted sum of the corresponding areas of the plurality of reference pictures; and
encoding a difference between the current block and the prediction block.

2. The method of claim 1, wherein the determining the corresponding areas of the plurality of reference pictures comprises:
determining a corresponding area of a first reference picture corresponding to the current block by predicting a motion of the current block;
dividing the corresponding area of the first reference picture into sub-corresponding areas along motion block boundaries of the first reference picture; and
determining corresponding areas of second reference pictures indicated by motion vectors of motion blocks of the first reference picture comprising the sub-corresponding areas of the first reference picture.

3. The method of claim 2, wherein the determining corresponding areas of the second reference pictures comprises:
if one of the sub-corresponding areas of the first reference picture is included in an intra-prediction block, determining a virtual motion vector of the intra-prediction block using motion vectors of neighboring motion blocks of the intra-prediction block; and
determining the corresponding areas of the second reference pictures indicated by the virtual motion vector.

4. The method of claim 3, wherein a median value or a mean value of the motion vectors of the neighboring motion blocks of the intra-prediction block is used as the virtual motion vector of the intra-prediction block.

5. The method of claim 1, wherein the tracking the motion vector route of the corresponding area of the reference picture comprises: determining a corresponding area of a second reference picture, indicated by a motion vector of the current block, to a corresponding area of an n-th reference picture indicated by a motion vector of an (n−1)-th reference picture,
wherein n is greater or equal to three, and
wherein the n-th reference picture is a reference picture of the (n−1)-th reference picture.

6. The method of claim 5, wherein the corresponding area of the n-th reference picture is included in only an intra-prediction block or intra-prediction blocks, and,
wherein, if only a portion of the corresponding area of the n-th reference picture is included in the intra-prediction block, an area of the portion is greater than a threshold value.

7. The method of claim 1, wherein the generating the prediction block of the current block comprises:
determining weights of the corresponding areas of the plurality of reference pictures; and
generating the prediction block of the current block by multiplying the weights by the corresponding areas of the plurality of reference pictures, respectively, and adding respective results of the multiplying.

8. The method of claim 7, wherein the weights are determined as values which minimize differences between prediction values of neighboring pixels of the current block obtained by calculating a weighted sum of neighboring pixels of the corresponding areas of the reference pictures and values of the neighboring pixels of the current block, using previously processed pixels of the neighboring blocks of the current block and the neighboring pixels of the corresponding areas of the reference pictures corresponding to the previously processed pixels of the neighboring blocks of the current block.

9. The method of claim 1, further comprising inserting a flag indicating a block prediction-encoded by using the plurality of reference pictures into a predetermined area of a bitstream generated by encoding the image.

10. The method of claim 1, wherein the determining the corresponding areas of the plurality of reference pictures comprises, if a portion of a corresponding area of a first reference picture included in an intra-prediction block is greater than a threshold value, determining only the corresponding area of the first reference picture as a corresponding area of a reference picture to be used to predict the current block,
wherein the generating a prediction block of the current block comprises determining a value obtained by multiplying a predetermined weight by the corresponding area of the first reference picture as the prediction block of the current block.

11. An image encoding apparatus comprising:
a reference picture determination unit that determines corresponding areas of a plurality of reference pictures that are to be used to predict a current block by tracking a motion vector route of a corresponding area of a reference picture referred to by the current block;
a weight estimation unit that generates a prediction block of the current block by calculating a weighted sum of the corresponding areas of the plurality of reference pictures; and
an encoding unit that encodes a difference between the current block and the prediction block.

12. The apparatus of claim 11, wherein the reference picture determination unit divides a corresponding area of a first reference picture indicated by a motion vector of the current block into sub-corresponding areas, along motion block boundaries of the first reference picture, and determines corresponding areas of second reference pictures indicated by motion vectors of motion blocks of the first reference picture comprising the sub-corresponding areas of the first reference picture.

13. The apparatus of claim 12, wherein if one of the sub-corresponding areas of the first reference picture is included in an intra-prediction block, the reference picture determination unit determines a virtual motion vector of the intra-prediction block using motion vectors of neighboring motion blocks of the intra-prediction block, and determines the corresponding areas of the second reference pictures indicated by the virtual motion vector.

14. The apparatus of claim 13, wherein a median value or a mean value of the motion vectors of the neighboring motion blocks of the intra-prediction block is used as the virtual motion vector of the intra-prediction block.

15. The apparatus of claim 11, wherein the reference picture determination unit determines a corresponding area of a second reference picture, indicated by a motion vector of the current block, to a corresponding area of an n-th reference picture indicated by a motion vector of an (n−1)-th reference picture,
wherein n is greater or equal to three, and
wherein the n-th reference picture is a reference picture of the (n−1)-th reference picture.

16. The apparatus of claim 15, wherein the corresponding area of the n-th reference picture is included in only an intra-prediction block or intra-prediction blocks, and,
wherein, if only a portion of the corresponding area of the n-th reference picture is included in the intra-prediction block, an area of the portion is greater than a threshold value.

17. The apparatus of claim 11, wherein the weight estimation unit comprises:
a weight calculation unit that determines weights of the corresponding areas of the plurality of reference pictures; and
a prediction block generation unit that generates the prediction block of the current block by multiplying the weights by the corresponding areas of the plurality of reference pictures, respectively, and adding respective results of the multiplying.

18. The apparatus of claim 17, wherein the weight calculation unit determines the weights as values which minimize differences between prediction values of neighboring pixels of the current block obtained by calculating a weighted sum of neighboring pixels of the corresponding areas of the reference pictures and values of the neighboring pixels of the current block, using previously processed pixels of the neighboring blocks of the current block and the neighboring pixels of the corresponding areas of the reference pictures corresponding to the previously processed pixels of the neighboring blocks of the current block.

19. The apparatus of claim 11, wherein the encoding unit inserts a flag indicating a block prediction-encoded by using the plurality of reference pictures into a predetermined area of a bitstream generated by encoding the image.

20. The apparatus of claim 11, wherein if a portion of a corresponding area of a first reference picture included in an intra-prediction block is greater than a threshold value, the reference picture determination unit determines only the corresponding area of the first reference picture as a corresponding area of a reference picture to be used to predict the current block,
wherein the weight estimation unit determines a value obtained by multiplying a predetermined weight by the corresponding area of the first reference picture as the prediction block of the current block.

21. An image decoding method comprising:
identifying a prediction mode of a current block by reading prediction mode information included in an input bitstream;
if the current block is determined to have been predicted using corresponding areas of a plurality of reference pictures, determining the corresponding areas of the plurality of reference pictures that are to be used to predict the current block by tracking a corresponding area of a reference picture referred to by a motion vector route of the current block included in the bitstream and a motion vector route of the corresponding area of the reference picture;
generating a prediction block of the current block by calculating a weighted sum of the corresponding areas of the plurality of reference pictures; and
decoding the current block by adding a difference between the current block included in the bitstream and the prediction block, and the prediction block.

22. The method of claim 21, wherein the determining the corresponding areas of the plurality of reference pictures comprises:
dividing a corresponding area of a first reference picture indicated by a motion vector of the current block along motion block boundaries of the first reference picture; and
determining corresponding areas of second reference pictures indicated by motion vectors of motion blocks of the first reference picture comprising the sub-corresponding areas of the first reference picture.

23. The method of claim 21, wherein the tracking a motion vector route of the corresponding area of the reference picture comprises determining a corresponding area of a second reference picture, indicated by a motion vector of the current block, to a corresponding area of an n-th reference picture indicated by a motion vector of an (n−1)-th reference picture,
wherein n is greater or equal to three, and
wherein the n-th reference picture is a reference picture of the (n−1)-th reference picture.

24. The method of claim 21, wherein the generating a prediction block of the current block comprises:
determining values which minimize differences between prediction values of neighboring pixels of the current block obtained by calculating a weighted sum of neighboring pixels of the corresponding areas of the reference pictures and values of the neighboring pixels of the current block, using previously processed pixels of the neighboring blocks of the current block and the neighboring pixels of the corresponding areas of the reference pictures corresponding to the previously processed pixels of the neighboring blocks of the current block, as weights of the corresponding areas of the plurality of reference pictures; and
generating the prediction block of the current block by multiplying the weights by the corresponding areas of the plurality of reference pictures, respectively, and adding respective results of the multiplying.

25. An image decoding apparatus comprising:
a prediction mode identification unit which identifies a prediction mode of a current block by reading prediction mode information included in an input bitstream;
a reference picture determination unit which, if the current block is determined to have been predicted using corresponding areas of a plurality of reference pictures, determines the corresponding areas of the plurality of reference pictures that are to be used to predict the current block by tracking a corresponding area of a reference picture referred to by a motion vector route of the current block included in the bitstream and a motion vector route of the corresponding area of the reference picture;
a weight prediction unit which generates a prediction block of the current block by calculating a weighted sum of the corresponding areas of the plurality of reference pictures; and
a decoding unit which decodes the current block by adding a difference between the current block included in the bitstream and the prediction block, and the prediction block.
